(19) United States
(12) Patent Application Publication
(10) Pub. No.: US 2025/0052862 A1
(43) Pub. Date: Feb. 13, 2025

(54) MILLIMETER-WAVE BEAM TRACKING METHOD IN MICROWAVE AND MILLIMETER WAVE HETEROGENEOUS NETWORK SCENARIO

(71) Applicant: JIAXING University, Jiaxing (CN)

(72) Inventors: Xianchao ZHANG, Jiaxing (CN); Yao ZHAO, Jiaxing (CN); Kai YANG, Jiaxing (CN)

(73) Assignee: JIAXING University, Jiaxing (CN)

(21) Appl. No.: 18/435,902

(22) Filed: Feb. 7, 2024

(30) Foreign Application Priority Data
Aug. 8, 2023 (CN) 202311006764.7

(51) Int. Cl. G01S 7/41; G01S 13/66

(52) U.S. Cl. CPC G01S 7/417; G01S 13/66

(57) ABSTRACT

The present invention relates to a millimeter-wave beam tracking method in a microwave and millimeter wave heterogeneous network scenario, including: establishing a millimeter-wave beam tracking problem in the microwave and millimeter wave heterogeneous network scenario; for the millimeter-wave beam tracking problem, constructing a deep neural network (DNN) fusion model that performs millimeter-wave beam tracking by using time sequence microwave channel information and user location information; pre-training the DNN fusion model by using training data; configuring a pre-trained beam tracking deep learning model in a base station controller of an actual access network, performing millimeter-wave beam tracking according to actually input microwave channel information and user location information, and selecting a millimeter-wave optimum beam; and collecting the input information to continuously train and update the DNN fusion model.

### CROSS-REFERENCE TO RELATED APPLICATION

This application claims priority to Chinese Patent Application No. 202311006764.7 filed on Aug. 8, 2023, the disclosure of which is hereby incorporated by reference in its entirety.

### BACKGROUND

Millimeter-wave communication is one of the key technologies required for future 5G/6G communication networks to provide high-capacity and high-rate wireless communication services. However, due to the high frequency band and short wavelength of millimeter wave, during the transmission, the free path loss is large and the penetration capability of the signal is weak. To remedy the defect, the massive multiple-input multiple-output (MIMO) antenna technology and beamforming technology are widely applied in the millimeter-wave communication to obtain multi-antenna gains to compensate for the loss.

To obtain a sufficiently large multi-antenna gain, the optimum beam direction needs to be continuously tracked for beamforming and the direction is used for communication. Currently, beam sweeping is used in the practical millimeter-wave communication system and communication standard, that is, before each transmission, a specified signal is used to measure the communication status of all beam directions. This causes high time and signal overheads, and may lead to a problem of outdated beam tracking result in a high-speed movement scenario. In consideration of this problem, the present invention proposes a millimeter-wave beam tracking method using microwave channel information and user location information to achieve low-overheads and fast beam tracking, and a high beamforming gain can be obtained, thereby ensuring that high-quality communication services are continuously provided for mobile users.

### SUMMARY

The present invention belongs to the technical field of wireless communication, and specifically, relates to a millimeter-wave beam tracking method in a microwave and millimeter wave heterogeneous network scenario.

In view of the foregoing analysis, the present invention aims to disclose a millimeter-wave beam tracking method in a microwave and millimeter wave heterogeneous network scenario, to resolve the prior-art problem of high beam tracking overheads and difficulty in obtaining millimeter-wave information.

The present invention discloses a millimeter-wave beam tracking method in a microwave and millimeter wave heterogeneous network scenario, including:
step S1: establishing a millimeter-wave beam tracking problem in the microwave and millimeter wave heterogeneous network scenario;
step S2: for the millimeter-wave beam tracking problem, constructing a deep neural network (DNN) fusion model that performs millimeter-wave beam tracking by using time sequence microwave channel information and user location information;
step S3: pre-training the DNN fusion model by using training data; and
step S4: configuring a pre-trained beam tracking deep learning model in a base station controller of an actual access network, performing millimeter-wave beam tracking according to actually input microwave channel information and user location information, and selecting a millimeter-wave optimum beam; and collecting the input information to continuously train and update the DNN fusion model.

Further the millimeter-wave beam tracking problem is: tracking beams from a plurality of millimeter-wave base stations by using one microwave base station in the microwave and millimeter wave heterogeneous network scenario in which microwave base stations and millimeter-wave base stations are independently and separately deployed and the quantity and density of the microwave base stations are less than the quantity and density of the millimeter-wave base stations.

Further, a mathematical expression of the millimeter-wave beam tracking problem is:

$$\{ {k}^{*} ( t ) , {m}^{*} ( t ) \} = {arg max}_{\begin{matrix}k ∈ \{ 1 , 2 , … , K \} \\ m ∈ \{ 1 , 2 , … , M \}\end{matrix}} {\vert {{H}_{mmW}^{( k )} ( t )}^{H} {f}_{m}^{( k )} \vert}^{2} \qquad Equation ( 1 )$$

where k*(t) represents the index of the millimeter-wave optimum base station at moment t, and m*(t) represents the index of the millimeter-wave optimum beam at moment t; H_{mmW}^{(k)}(t) is the channel state of the k^{th} millimeter-wave base station at moment t; and fₘ^{(k)} and m is the m^{th} candidate beam of the base station, K is the quantity of millimeter-wave base stations, and M is the quantity of beams.

Further, the DNN fusion model includes a microwave feature extraction module, a location feature extraction module, and a feature fusion module.

The microwave feature extraction module is configured to perform feature extraction by using historical time sequence microwave channel information as an input to obtain a first group of optimum beam probabilities.

The location feature extraction module is configured to perform feature extraction by using historical time sequence user location information as an input to obtain a second group of optimum beam probabilities.

The feature fusion module is configured to perform feature fusion by using the first and second groups of optimum beam probabilities as inputs to obtain and output millimeter-wave optimum beam probabilities obtained by tracking.

Further, the microwave feature extraction module includes a first long short-term memory (LSTM) module, a first decoder, and a first softmax module that are cascaded.

The first LSTM module is configured to extract the temporal dynamic features of a microwave channel from changes in input historical time sequence microwave channels.

The first decoder is a fully connected neural network (FCNN) and is configured to convert the temporal dynamic features of the microwave channel into millimeter-wave beam features.

The first softmax module is configured to classify the beam features output by the first decoder and output the first group of optimum beam probabilities.

The location feature extraction module includes a second LSTM module, a second decoder, and a second softmax module that are cascaded.

The second LSTM module is configured to extract the temporal dynamic features of a user location for the changes of input historical time sequence user locations.

The second decoder is an FCNN and is configured to convert the temporal dynamic features of the user location into millimeter-wave beam features.

The second softmax module is configured to classify the beam features output by the second decoder and output the second group of optimum beam probabilities.

The feature fusion module includes a batch normalization module, an attention module, and a classifier module.

The batch normalization module is configured to normalize the input first and second groups of optimum beam probabilities.

The attention module is configured to adjust the weights for the normalized first and second groups of optimum beam probabilities.

The classifier module is configured to fuse and analyze, based on the FCNN, the first and second groups of optimum beam probabilities that are normalized and whose weights are adjusted to output a final optimum beam probability.

Further, in step S3, the DNN fusion model is pre-trained in a self-supervised or supervised training manner.

In the self-supervised training manner, the training data is historical time sequence microwave channel information and user location information.

In the supervised training manner, the training data is historical time sequence microwave channel information, user location information, and the corresponding optimum beam label.

Further, in a self-supervised training manner, the training loss function is expressed as:

$${L}_{s} = {L}_{s}^{sub - 6} + {L}_{s}^{loc} + {L}_{s}^{fu} = - {\vert {{H}_{mmW}^{( {k}_{sub - 6} )} ( t )}^{H} {f}_{{m}_{sub - 6}}^{( {k}_{sub - 6} )} \vert}^{2} - {\vert {{H}_{mmW}^{( {k}_{loc} )} ( t )}^{H} {f}_{{m}_{loc}}^{( {k}_{loc} )} \vert}^{2} - {\vert {{H}_{mmW}^{( {k}_{fu} )} ( t )}^{H} {f}_{{m}_{fu}}^{( {k}_{fu} )} \vert}^{2} \qquad Equation ( 2 )$$

where Lₛ^{sub-6}, Lₛ^{loc}, and Lₛ^{fu} are the loss functions of the microwave feature extraction module, the location feature extraction module, and the feature fusion module, respectively; and k_{sub-6}, m_{sub-6}, k_{loc}, m_{loc}, k_{fu} and m_{fu} represent the access base stations and beams selected according to beam prediction results obtained by the microwave feature extraction module, the location feature extraction module, and the feature fusion module, respectively.

Further, in a supervised training manner, the training loss function is expressed as:

$$L = {L}_{CE}^{sub - 6} + {L}_{CE}^{loc} + {L}_{CE}^{fu} = - {\sum }_{m = 1}^{KM} {δ}_{m} ( t ) ( {log}_{2} ( {p}_{m}^{sub - 6} ) + {log}_{2} ( {p}_{m}^{loc} ) + {log}_{2} ( {p}_{m} ) ) \qquad Equation ( 3 )$$

where L_{CE}^{sub-6}, L_{CE}^{loc}, and L_{CE}^{fu} are cross entropy loss functions of the microwave feature extraction module, the location feature extraction module, and the feature fusion module, respectively; {δ₁(t), . . . , δₘ(t), . . . , δ_{KM}(t)} is a one-hot vector that represents the optimum beam at moment t, that is, if m*(t)=m, δₘ(t)=1; otherwise, δₘ(t)=0; KM=K×M; pₘ^{sub-6} is a probability that the microwave feature extraction module determines that each beam is an optimum beam; pₘ^{loc} is a probability that the location feature extraction module determines that each beam is an optimum beam; and pₘ is a probability that the feature fusion module determines that each beam is an optimum beam.

Further, based on the established beam tracking problem, a mapping from historical time sequence microwave channel information and user location information to the millimeter-wave optimum beam is established, and an optimum beam label, that is corresponding to historical time sequence microwave channel information and user location information which are required for supervised training, is obtained.

The established mapping from the historical time sequence microwave channel information and the user location information to the millimeter-wave optimum beam is:

$$Φ : {\{ {H}_{sub - 6} ( t - τ ) , q ( t - τ ) \}}_{τ = 1}^{T} \to \{ {k}^{*} ( t ) , {m}^{*} ( t ) \} \qquad Equation ( 4 )$$

where T represents the time length of the historical time sequence microwave channel information, H_{sub-6}(t−τ) represents the microwave channel state at moment t−τ; q(t−τ) represents the user location at moment t−τ; and k*(t) represents the index of the millimeter-wave optimum base station at moment t, and m*(t) represents the index of the millimeter-wave optimum beam at moment t.

Further, the mapping from the historical time sequence microwave channel information and the user location information to the millimeter-wave optimum beam is established by using a DNN; and the corresponding optimum beam is obtained according to the historical time sequence microwave channel information and the user location information. The present invention can achieve one of the following beneficial effects:
1. A deep learning technology is used for beam tracking, and a trained DNN can directly provide the optimum beam direction based on input information. This avoids time and signal overheads caused by beam sweeping. In addition, a DNN has low calculation complexity and is easy to implement.
2. Microwave channel information and geographical location information are used as inputs to the DNN for beam tracking. Compared with millimeter wave channel information, accurate microwave channel information is easier to obtain in practice, because the microwave channel estimation technology has been widely used in practice and is more mature, and compared with millimeter waves, microwave propagation is smaller in fading and wider in coverage. In addition, the process of obtaining microwave channel information and user location information does not interfere with normal millimeter-wave communication.
3. In consideration of the high-speed mobility of users, compared with other DNN models, performing beam tracking by using LSTM, historical time sequence microwave channel information, and user location information can achieve better performance in extracting channel features and predicting the optimum beam.
4. An LSTM fusion model is provided, microwave channel information and geographical location information are input at the same time, and features of the two are effectively extracted and fused to improve performance in tracking a millimeter-wave beam in this scenario.
5. A neural network model is trained in a self-supervised training manner, such that there is no need to collect a large amount of data, facilitating self-updating and self-learning of the model in practice.

### BRIEF DESCRIPTION OF THE DRAWINGS

The accompanying drawings are provided merely for illustrating the specific embodiments, and are not considered to be limitations of the present disclosure. The same reference numerals represent the same components throughout the accompanying drawings.

FIG. 1 is a flowchart of a millimeter-wave beam tracking method in a microwave and millimeter wave heterogeneous network scenario according to an embodiment of the present invention;

FIG. 2 is a schematic diagram of a microwave and millimeter wave heterogeneous network scenario according to an embodiment of the present invention;

FIG. 3 is a schematic structural diagram of a DNN fusion model according to an embodiment of the present invention; and

FIG. 4 is a schematic structural diagram of an LSTM model according to an embodiment of the present invention.

### DETAILED DESCRIPTION

Preferred embodiments of the present invention will be described in detail below with reference to the accompanying drawings. The accompanying drawings constitute a part of the present disclosure, and are used together with the embodiments of the present disclosure to explain the principles of the present disclosure.

An embodiment of the present invention discloses a millimeter-wave beam tracking method in a microwave and millimeter wave heterogeneous network scenario. In this embodiment, dual connectivity communication between vehicles and microwave/millimeter-wave base stations in a city is used as an example.

The microwave carrier frequency is set to 3.5 GHz. The microwave base station uses a two-dimensional multi-antenna array. The millimeter-wave carrier frequency is 28 GHz. The millimeter-wave base station uses a two-dimensional multi-antenna array. The quantity of beams is the same as that of antennas. The two base stations each have a transmit power of 23 dBm, a noise power of −174 dBm/Hz, and a noise figure of 3 dB. The quantity of multi-paths is 30. The beam tracking period is 20 ms. The vehicle speed is 20 m/s.

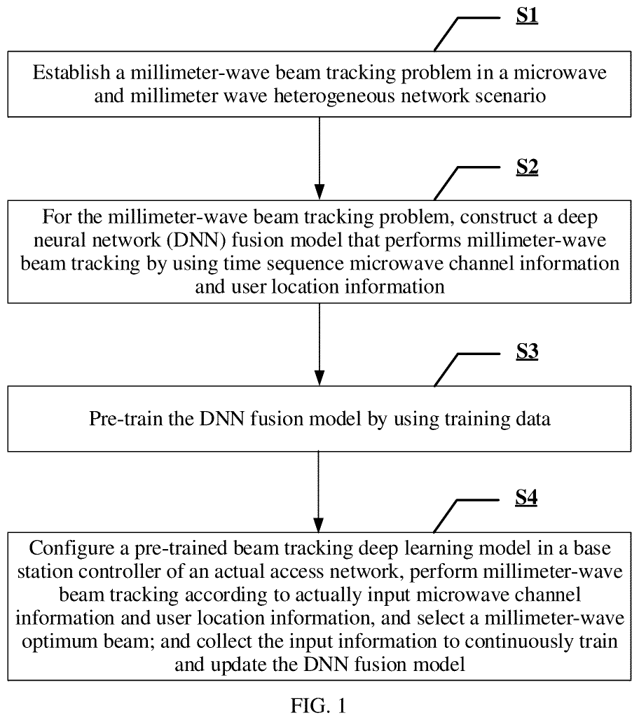

Specifically, as shown in FIG. 1, the millimeter-wave beam tracking method in a microwave and millimeter wave heterogeneous network scenario of this embodiment includes the following steps:
Step S1: Establish a millimeter-wave beam tracking problem in the microwave and millimeter wave heterogeneous network scenario.
Step S2: For the millimeter-wave beam tracking problem, construct a DNN fusion model that performs millimeter-wave beam tracking by using time sequence microwave channel information and user location information.
Step S3: Pre-train the DNN fusion model by using training data, and enable the model to achieve a mapping from historical time sequence microwave channel information and the user location information to a millimeter-wave optimum beam.
Step S4: Configure a pre-trained beam tracking deep learning model in a base station controller of an actual access network, perform millimeter-wave beam tracking according to actually input microwave channel information and user location information, and select a millimeter-wave optimum beam; and collect the input information to continuously train and update the DNN fusion model.

Specifically, the millimeter-wave beam tracking problem in step S1 is: tracking beams from a plurality of millimeter-wave base stations by using one microwave base station in the microwave and millimeter wave heterogeneous network scenario in which microwave base stations and millimeter-wave base stations are independently and separately deployed and the quantity and density of the microwave base stations are less than the quantity and density of the millimeter-wave base stations. That is, the problem is a continuous optimum beam selection problem.

More specifically, the process of establishing a millimeter-wave beam tracking problem in step S1 includes the following steps:

(1) Establish mathematical models for microwave channels and millimeter-wave channels.

It is assumed that the microwave base station and the millimeter-wave base station are equipped with multi-antenna uniform planar arrays (UPAs) in dimensions of N_{sub-6}=N_{y}^{sub-6}×N_{z}^{sub-6} and N_{mmW}=N_{y}^{mmW}×N_{z}^{mmW}, respectively. N_{y}^{sub-6}, N_{z}^{sub-6}, N_{y}^{mmW}, and N_{z}^{mmW} are quantities of microwave and millimeter-wave array antennas in y and z-axis directions, respectively, and microwave and millimeter-wave users are equipped with single antennas.

Herein, a ray-based multi-path channel model is used to describe microwave and millimeter-wave propagation environments. Specifically, antenna quantities of the antenna array in the y and z-axis directions are set to N_{y} and N_{z}, respectively. When N=N_{y}×N_{z} antennas are equipped, the corresponding channel at moment t can be expressed as:

$$H ( t , f , {N}_{y} , {N}_{z} ) = {\sum }_{l = 1}^{L} {α}_{l} {e}^{j 2 π ( {v}_{l} t - {τ}_{l} f )} a ( {N}_{y} , {N}_{z} , u ( t ) , v ( t ) ) \qquad Equation ( 5 )$$

where L represents the quantity of multi-paths, α₁, v₁, and τ₁ represent the channel complex gain, the Doppler shift, and the delay of the l^{th} propagation path, respectively, ƒ is the carrier frequency, and a(N_{y},N_{z},u(t),v(t)) refers to the steering vector corresponding to a UPA in dimensions of N_{y}×N_{y}, which can be specifically expressed as:

$$a ( {N}_{y} , {N}_{z} , u ( t ) , v ( t ) ) = a ( {N}_{y} u ( t ) ) ⊗ a ( {N}_{z} , v ( t ) ) \qquad Equation ( 6 )$$

$$where$$

$$\begin{matrix}a ( {N}_{y} , u ( t ) ) = {[ 1 , {e}^{j 2 π \frac{d}{λ} u ( t )} , … , {e}^{j 2 π \frac{d}{λ} ( {N}_{y} - 1 ) u ( t )} ]}^{T} \\ a ( {N}_{z} , v ( t ) ) = {[ 1 , {e}^{j 2 π \frac{d}{λ} v ( t )} , … , {e}^{j 2 π \frac{d}{λ} ( {N}_{z} - 1 ) v ( t )} ]}^{T}\end{matrix} \qquad Equation ( 7 )$$

where ⊗ represents a Kronecker product, T is a transpose operation, d is the antenna spacing, which is generally set to be d=λ/2 and λ is the wavelength; and u(t)=cosϕ(t)sinθ(t) , v(t)=cosθ(t) , and ϕ(t) and θ(t) represent the azimuth and elevation angles of departure at moment t, respectively.

Based on the foregoing channel and steering vector at moment t, the following can be obtained:

The microwave link channel at moment t is expressed as:

$${H}_{sub - 6} ( t ) = H ( t , {f}_{sub - 6} , {N}_{y}^{sub - 6} , {N}_{z}^{sub - 6} ) \qquad Equation ( 8 )$$

And the millimeter-wave link channel at moment t is expressed as:

$${H}_{mmW} ( t ) - H ( t , {f}_{mmW} , {N}_{y}^{mmW} , {N}_{z}^{mmW} ) \qquad Equation ( 9 )$$

where ƒ_{sub-6} and ƒ_{mmW} represent the carrier frequencies of microwave link and millimeter-wave link, respectively.

(2) Establish a representation model for the millimeter-wave channel.

It is assumed that each millimeter-wave base station has only one radio frequency chain and uses an analog beamforming technology based on a phase shifter. A beamforming vector at moment t is expressed as f(t)∈ [symbol] ^{N}^{_{mmW}}^{x1} . The vector is selected from a predefined codebook F based on the discrete Fourier transform. If there are M=M_{y}×M_{z}. candidate beams, where M_{y} and M_{z} represent beam quantities in the y and z-axis directions, respectively, the m^{th} beam can be expressed as:

$${f}_{m} = {f}_{m}^{y} ⊗ {f}_{m}^{z} \qquad Equation ( 10 )$$

$$where$$

$${f}_{m}^{y} = {\frac{1}{\sqrt{{N}_{y}^{mmW}}} [ 1 , {e}^{j π {γ}_{m}^{y}} , … , {e}^{j π ( {N}_{y}^{mmW} - 1 ) {γ}_{m}^{y}} ]}^{⊤} \qquad Equation ( 11 )$$

$${f}_{m}^{z} = {\frac{1}{\sqrt{{N}_{z}^{mmW}}} [ 1 , {e}^{j π {γ}_{m}^{z}} , … , {e}^{j π ( {N}_{z}^{mmW} - 1 ) {γ}_{m}^{z}} ]}^{⊤}$$

where γₘ^{y} andγₘ^{z} are beam phases on the y and z axes of the m^{th} beam, respectively. The codebook is set to cover the entire angle domain, that is, [−π,π]. In this case, γₘ^{y} and Yₘ^{z} are obtained through uniform sampling from an interval [−1,1], that is,

$$\begin{matrix}{γ}_{m}^{y} = - 1 + \frac{2 m - 1}{{M}_{y}} ; & {γ}_{m}^{z} = - 1 +\end{matrix} \frac{2 m - 1}{{M}_{z}} .$$

According to the millimeter-wave channel H_{mmW}(t) and the beamforming vector f(t) at moment t, a representation model for the millimeter-wave received signal at moment t is established as:

$$s ( t ) = \sqrt{P} {{H}_{mmW} ( t )}^{H} f ( t ) x ( t ) + n ( t ) \qquad Equation ( 12 )$$

where P is the millimeter-wave transmit power, H is a conjugate transpose operation, and x(t) represents the transmit signal at moment t. The transmit power is set to be 1, that is, |x(t) |=1 n(t) is the additive white Gaussian noise at moment t. If the noise power is set to be σ², n(t)˜CN (0,σ²)

(3) Establish a mathematical expression for the millimeter-wave beam tracking problem based on the representation model of the millimeter-wave signal.

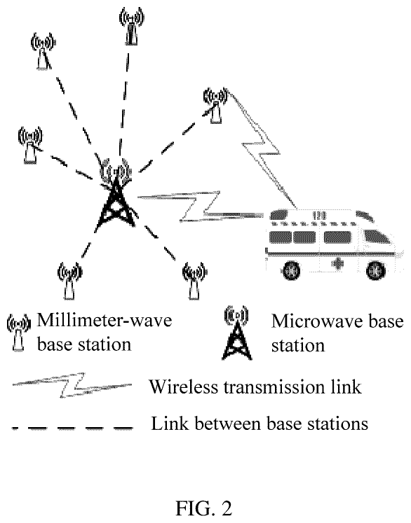

The millimeter-wave beam tracking aims to track the optimum beam direction from all candidate beam directions to maximize the beamforming gain. The present invention intends to use microwave channel information and user location information to perform millimeter-wave beam tracking. According to actual and possible future cellular network base station distributions, considering a microwave and millimeter wave heterogeneous network scenario, the specific scenario is shown in FIG. 2. In this scenario, microwave and millimeter-wave base stations are independently and separately deployed, and the quantity and density of microwave base stations are less than those of millimeter-wave base stations in practice. In this scenario, one microwave base station needs to track beams from a plurality of millimeter-wave base stations.

A corresponding millimeter wave tracking problem is established for the foregoing scenario. Because the optimum beam is to be selected from candidate beams of a plurality of millimeter-wave base stations, not only the optimum beam needs to be found, but also an optimum base station of the beam needs to be found. It is assumed that one microwave base station needs to control K millimeter-wave base stations, which is equivalent to finding the optimum beam from all K×M beams.

If the channel state of the k^{th} millimeter-wave base station at moment t is expressed H_{mmW}^{(k)}(t), and the m^{th} candidate beam of the base station is fₘ^{(k)}, in a millimeter wave heterogeneous network scenario, the mathematical expression of the beam tracking problem is:

$$\{ {k}^{⋆} ( t ) , {m}^{⋆} ( t ) \} = {arg max}_{{k ϵ \{ 1 , 2 , … , K \}}_{m ϵ \{ 1 , 2 , … , M \}}} \vert {{H}_{mmW}^{( k )} ( t )}^{H} {f}_{m}^{( k )} {\vert}^{2} ; \qquad Equation ( 13 )$$

where k*(t) represents the index of an optimum millimeter-wave base station at moment t, and m*(t) represents the index of a millimeter-wave optimum beam at moment t.

More specifically, based on the established beam tracking problem, a mapping from historical time sequence microwave channel information and user location information to the millimeter-wave optimum beam is established, and an optimum beam corresponding to the historical time sequence microwave channel information and the user location information is obtained and can be used as an optimum beam label required for subsequent supervised training.

The mapping established from the historical time sequence microwave channel information and the user location information to the millimeter-wave optimum beam is:

$$Φ : {\{ {H}_{sub - 6} ( t - τ ) , q ( t - τ ) \}}_{τ = 1}^{T} \to \{ {k}^{⋆} ( t ) , {m}^{⋆} ( t ) \} \qquad Equation ( 14 )$$

where T represents a time length of the historical time sequence microwave channel information, H_{sub-6}(t−τ) represents a microwave channel state at moment t−σ; q(t−σ) represents a user location at moment t−σ; and k*(t) represents the index of the millimeter-wave optimum base station at moment t, and m*(t) represents the index of the millimeter-wave optimum beam at moment t.

Preferably, the mapping from the historical time sequence microwave channel information and the user location information to the millimeter-wave optimum beam is established by using a deep neural network (DNN). The corresponding optimum beam is obtained according to the historical time sequence microwave channel information and the user location information.

Specifically, in step S2, for the beam tracking problem, a DNN fusion model based on long short-term memory (LSTM) is constructed to implement the mapping from the historical time sequence microwave channel information and the user location information to the millimeter-wave optimum beam.

In the scenario of this embodiment, the microwave and millimeter-wave base stations are distributed at different locations, the channels are not strongly correlated, and one microwave base station needs to manage a plurality of millimeter-wave base stations. Therefore, using only microwave channels for beam tracking is ineffective.

In the DNN fusion model based on LSTM that is provided in this embodiment, both microwave channel information and user location information are used for beam tracking in the heterogeneous network scenario.

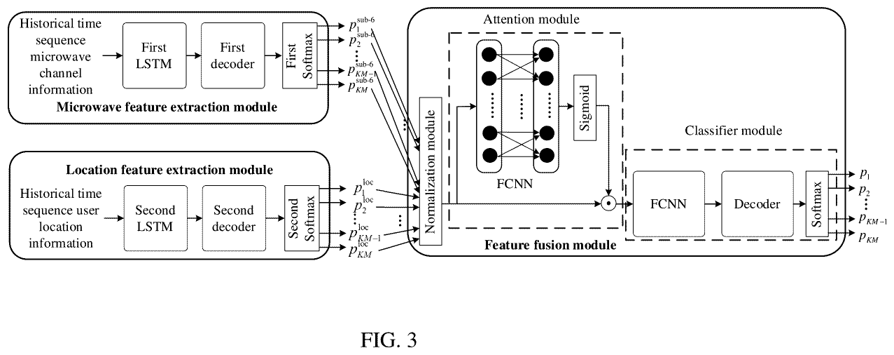

Specifically, as shown in FIG. 3, the structure of the DNN fusion model includes a microwave feature extraction module, a location feature extraction module, and a feature fusion module.

The microwave feature extraction module is configured to perform feature extraction by using historical time sequence microwave channel information as an input to obtain a first group of optimum beam probabilities p₁^{sub-6}, . . . , p_{KM}^{sub-6}.

The location feature extraction module is configured to perform feature extraction by using historical time sequence user location information as an input to obtain a second group of optimum beam probabilities p₁^{loc}, . . . , p_{KM}^{loc}.

The beam quantities for the probabilities output by the microwave feature extraction module and the location feature extraction module are both KM.

The feature fusion module is configured to perform feature fusion by using the first and second groups of optimum beam probabilities as inputs to obtain and output millimeter-wave optimum beam probabilities p₁, . . . , p_{KM} obtained by tracking.

In this embodiment, considering all beams of all base stations uniformly, KM is set to be a total beam quantity of KM=K×M.

More specifically, the microwave feature extraction module includes a first LSTM module, a first decoder, and a first softmax module that are cascaded.

The first LSTM module is configured to extract temporal dynamic features of a microwave channel from changes in input historical time sequence microwave channels.

The first decoder is a fully connected neural network (FCNN) and is configured to convert the temporal dynamic features of the microwave channel into millimeter-wave beam features.

The first softmax module is configured to classify the beam features output by the first decoder and output a first group of optimum beam probabilities.

The location feature extraction module includes a second LSTM module, a second decoder, and a second softmax module that are cascaded.

The second LSTM module is configured to extract temporal dynamic features of a user location for the change of input historical time sequence user locations.

The second decoder is an FCNN and is configured to convert the temporal dynamic features of the user location into millimeter-wave beam features.

The second softmax module is configured to classify the beam features output by the second decoder and output a second group of optimum beam probabilities.

The feature fusion module includes a batch normalization module, an attention module, and a classifier module.

The batch normalization module is configured to normalize the input first and second groups of optimum beam probabilities.

The attention module is configured to adjust the weights for the normalized first and second groups of optimum beam probabilities.

The classifier module is configured to fuse and analyze, based on the FCNN, the first and second groups of optimum beam probabilities that are normalized and whose weights are adjusted to output a final optimum beam probability.

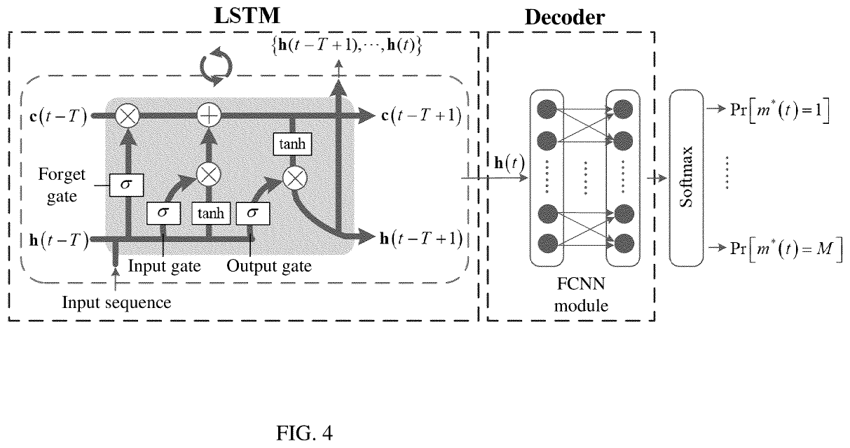

In this embodiment, an LSTM model is shown in FIG. 4. Two LSTM models are used to each input one segment of historical time sequence microwave channel information and user location information. Based on a recurrent neural network (RNN) architecture, LSTM can accumulate, by using internal states (memory), temporal dynamic features of inputs that are captured at previous states to comprehensively analyze an input time sequence. Compared with the conventional RNN, the LSTM has an input gate, an output gate, and a forget gate added, as shown in FIG. 4, to control an information flow to enter and exit a network unit, thereby discarding unnecessary information and focusing on important information, with an advantage of being capable to process a long-term sequence.

After the LSTM analyzes temporal dynamic features of changes in microwave channels and user locations, a decoder, that is, the FCNN module in FIG. 3, and a softmax function are used to perform a beam selection task. Herein, beam tracking, that is, optimum beam selection, is performed as a classification task in deep learning. Each beam direction may be considered as a category and the deep learning model classifies input information into a corresponding category. Therefore, the decoder in FIG. 3 and the softmax activation function serve as a classifier, and can obtain a probability that each beam is the optimum beam, that is, Pr[m*(t)=m]. Subsequently, a beam with the highest probability is selected. This is referred to as a Top-1 beam tracking method. Alternatively, n beams with highest probabilities are selected as candidate optimum beams, and scanning is further performed on the candidate beams to select a beam with the best performance. This is referred to as a Top-n beam tracking method.

In addition, steps of two LSTM modules are as follows. The microwave feature extraction module inputs a segment of historical time sequence microwave channel information to the LSTM classifier to extract dynamic channel features and provide a group of optimum beam probabilities, expressed as p₁^{sub-6}, . . . , p_{KM}^{sub-6} in FIG. 3. For simplicity, herein the problems in the two steps of selecting an optimum base station and an optimum beam in the heterogeneous network scenario are combined into a problem of directly selecting an optimum beam from a plurality of base stations. The finally selected optimum beam also includes the selection of the optimum base station. Therefore, probabilities need to be provided for a total of KM beams. The location feature extraction module inputs a segment of historical time sequence user location information to the LSTM classifier to extract user movement features and provide a group of optimum beam probabilities, and obtain another beam prediction result, that is, p₁^{loc}, . . . , p_{KM}^{loc} in FIG. 3.

Two beam tracking results obtained according to the microwave channel information and the user location information respectively are sent to the final feature fusion module, which provides a final beam tracking result, as shown in FIG. 3. Specifically, the foregoing two results are first input to a batch normalization (BN) layer for standardization, and then provided to an attention layer including an FCNN and a sigmoid activation function for learning. In addition, weighting coefficients of microwave and location feature inputs are adjusted. Assuming that the output of the BN layer is p_{BN}, the output of the attention layer may be expressed as:

$${p}_{A} = {p}_{BN} ▯ {w}_{f} \qquad Equation ( 15 )$$

where [symbol] is a symbol of multiplication between elements, and w_{f} is a learnable weight of an input feature and specifically expressed as:

$${w}_{f} = sigmoid ( {W}_{A} {p}_{BN} + {b}_{A} ) \qquad Equation ( 16 )$$

where W_{A} and b_{A} are the weight and bias of the FCNN in the attention layer, WA and respectively. Subsequently, an FCNN-based classifier is used to fuse and analyze the microwave and location feature inputs that are standardized and whose weights are adjusted, and to provide a final optimum beam probability, that is, p₁, . . . , p_{KM} in FIG. 3.

Specifically, in step S3, the DNN fusion model is pre-trained in an unsupervised or supervised training manner.

In the self-supervised training manner, the training data is historical time sequence microwave channel information and user location information.

In the supervised training manner, the training data is historical time sequence microwave channel information, user location information, and a corresponding optimum beam label.

In the self-supervised training manner, that is, a training loss function is directly set to be related to the optimization purpose of this problem. The optimization purpose of this problem is to maximize the beamforming gain, while deep learning training aims to minimize the loss function. Therefore, the training loss function can be set to a negative value of the optimization purpose of this problem to achieve the unification of the two, that is, the training loss function is expressed as:

$${L}_{s} = {L}_{s}^{sub - 6} + {L}_{s}^{loc} + {L}_{s}^{fu} = - \vert {{H}_{mmW}^{( {k}_{sub - 6} )} ( t )}^{H} {f}_{{m}_{sub - 6}}^{( {k}_{sub - 6} )} {\vert}^{2} - \vert {{H}_{mmW}^{( {k}_{loc} )} ( t )}^{H} {f}_{{m}_{loc}}^{( {k}_{loc} )} {\vert}^{2} - \vert {{H}_{mmW}^{( {k}_{fu} )} ( t )}^{H} {f}_{{m}_{fu}}^{( {k}_{fu} )} {\vert}^{2} \qquad Equation ( 17 )$$

where Lₛ^{sub-6},Lₛ^{loc}, and Lₛ^{fu} are loss the functions of the first feature extraction module, the second feature extraction module, and the feature fusion module, respectively; and k_{sub-6}, m_{sub-6}, k_{loc}, m_{loc}, k_{fu}, and m_{fu} represent access base stations and beams selected according to beam prediction results obtained by the microwave feature extraction module, the location feature extraction module, and the feature fusion module, respectively.

All data in the loss function formula is generated by the model on its own, and no external data is required. Therefore, this is referred to as a self-supervised training method.

When the training data is historical time sequence microwave channel information, user location information and the corresponding optimum beam label, the supervised training manner is used. The optimum beam label may be obtained through conventional beam scanning or calculation according to millimeter-wave channel information.

In the supervised training manner, the training loss function is expressed as:

$$L = {L}_{CE}^{sub - 6} + {L}_{CE}^{loc} + {L}_{CE}^{fu} = - {\sum }_{m = 1}^{KM} {δ}_{m} ( t ) ( {log}_{2} ( {p}_{m}^{sub - 6} ) + {log}_{2} ( {p}_{m}^{loc} ) + {log}_{2} ( {p}_{m} ) ) \qquad Equation ( 18 )$$

where {δ₁(t), . . . , δₘ(t), . . . , δ_{KM}(t)} is a one-hot vector that represents an optimum beam at moment t, that is, if m*(t)=m, δₘ(t)=1; otherwise, δₘ(t)=0. This part needs to be obtained from the training data. L_{CE}^{sub-6}, L_{CE}^{loc}, and L_{CE}^{fu} are cross entropy loss functions of the microwave feature extraction module, the location feature extraction module, and the feature fusion module, respectively. pₘ^{sub-6} is a probability that the microwave feature extraction module determines that each beam is the optimum beam. pₘ^{loc} is a probability that the location feature extraction module determines that each beam is the optimum beam. pₘ is a probability that the feature fusion module determines that each beam is the optimum beam.

A general expression of each cross entropy loss function is:

$${L}_{CE = -} {\sum }_{m = 1}^{M} {δ}_{m} ( t ) {log}_{2} ( Pr [ {m}^{⋆} ( t ) = m ] ) . \qquad Equation ( 19 )$$

In step S4, a pre-trained beam tracking deep learning model is configured in a base station controller of an actual access network, millimeter-wave beam tracking is performed according to actually input microwave channel information and user location information, and a millimeter-wave optimum beam is selected. In this way, time and signal overheads caused by beam scanning are avoided. In addition, actual input information is collected to continuously train and update the DNN fusion model, such that the DNN fusion model always matches the heterogeneous network scenario.

To sum up, the embodiments of the present disclosure achieve the following beneficial effects:
1. A deep learning technology is used for beam tracking, and a trained DNN can directly provide an optimum beam direction based on input information. This avoids time and signal overheads caused by beam sweeping. In addition, a DNN has low calculation complexity and is easy to implement.
2. Microwave channel information and geographical location information are used as inputs to the DNN for beam tracking. Compared with millimeter wave channel information, accurate microwave channel information is easier to obtain in practice, because a microwave channel estimation technology has been widely used in practice and is more mature, and compared with millimeter waves, microwave propagation is smaller in fading and wider in coverage. In addition, the process of obtaining microwave channel information and user location information does not interfere with normal millimeter-wave communication.
3. In consideration of high-speed mobility of users, compared with other DNN models, performing beam tracking by using LSTM, historical time sequence microwave channel information, and user location information can achieve better performance in extracting channel features and predicting the optimum beam.
4. An LSTM fusion model is provided, microwave channel information and geographical location information are input at the same time, and features of the two are effectively extracted and fused to improve performance in tracking a millimeter-wave beam in this scenario.
5. A neural network model is trained in a self-supervised training manner, such that there is no need to collect a large amount of data, facilitating self-updating and self-learning of the model in practice.

The above are merely preferred specific implementations of the present disclosure, but the protection scope of the present disclosure is not limited thereto. Any modification or replacement easily conceived by those skilled in the art within the technical scope of the present disclosure should fall within the protection scope of the present disclosure.

What is claimed is:

1. A millimeter-wave beam tracking method in a microwave and millimeter wave heterogeneous network scenario, comprising:
step S1: establishing a millimeter-wave beam tracking problem in the microwave and millimeter wave heterogeneous network scenario;
step S2: for the millimeter-wave beam tracking problem, constructing a deep neural network (DNN) fusion model that performs millimeter-wave beam tracking by using time sequence microwave channel information and user location information;
step S3: pre-training the DNN fusion model by using training data; and
step S4: configuring a pre-trained beam tracking deep learning model in a base station controller of an actual access network, performing millimeter-wave beam tracking according to actually input microwave channel information and user location information, and selecting a millimeter-wave optimum beam; and collecting the input information to continuously train and update the DNN fusion model.

2. The millimeter-wave beam tracking method in the microwave and millimeter wave heterogeneous network scenario according to claim 1, wherein
the millimeter-wave beam tracking problem is: tracking beams from a plurality of millimeter-wave base stations by using one microwave base station in the microwave and millimeter wave heterogeneous network scenario in which microwave base stations and millimeter-wave base stations are independently and separately deployed and the quantity and density of the microwave base stations are less than the quantity and density of the millimeter-wave base stations.

3. The millimeter-wave beam tracking method in the microwave and millimeter wave heterogeneous network scenario according to claim 2, wherein
a mathematical expression of the millimeter-wave beam tracking problem is:
$$\{ {k}^{⋆} ( t ) , {m}^{⋆} ( t ) \} = {arg max}_{{k ϵ \{ 1 , 2 , … , K \}}_{m ϵ \{ 1 , 2 , … , M \}}} \vert {{H}_{mmW}^{( k )} ( t )}^{H} {f}_{m}^{( k )} {\vert}^{2} ;$$
wherein k*(t) represents the index of the millimeter-wave optimum base station at moment t, and m*(t) represents the index of the millimeter-wave optimum beam at moment t; H_{mmW}^{(k)}(t) is the channel state of the k^{th} millimeter-wave base station at moment t; and fₘ^{(k)} is the m^{th} candidate beam of the base station, K is the quantity of the millimeter-wave base stations, and M is the quantity of beams.

4. The millimeter-wave beam tracking method in the microwave and millimeter wave heterogeneous network scenario according to claim 3, wherein the DNN fusion model comprises a microwave feature extraction module, a location feature extraction module, and a feature fusion module;
the microwave feature extraction module is configured to perform feature extraction by using historical time sequence microwave channel information as an input to obtain a first group of optimum beam probabilities;
the location feature extraction module is configured to perform feature extraction by using historical time sequence user location information as an input to obtain a second group of optimum beam probabilities; and
the feature fusion module is configured to perform feature fusion by using the first group of optimum beam probabilities and the second group of optimum beam probabilities as inputs to obtain and output millimeter-wave optimum beam probabilities obtained by tracking.

5. The millimeter-wave beam tracking method in the microwave and millimeter wave heterogeneous network scenario according to claim 4, wherein
the microwave feature extraction module comprises a first long short-term memory (LSTM) module, a first decoder, and a first softmax module that are cascaded, wherein
the first LSTM module is configured to extract the temporal dynamic features of a microwave channel from changes in input historical time sequence microwave channels;
the first decoder is a fully connected neural network (FCNN) and is configured to convert the temporal dynamic features of the microwave channel into millimeter-wave beam features; and
the first softmax module is configured to classify the beam features output by the first decoder and output the first group of optimum beam probabilities;
the location feature extraction module comprises a second LSTM module, a second decoder, and a second softmax module that are cascaded, wherein
the second LSTM module is configured to extract the temporal dynamic features of a user location from changes in input historical time sequence user locations;
the second decoder is an FCNN and is configured to convert the temporal dynamic features of the user location into millimeter-wave beam features; and
the second softmax module is configured to classify the beam features output by the second decoder and output the second group of optimum beam probabilities; and
the feature fusion module comprises a batch normalization module, an attention module, and a classifier module, wherein
the batch normalization module is configured to normalize the input first and second groups of optimum beam probabilities;
the attention module is configured to adjust the weights for the normalized first and second groups of optimum beam probabilities; and
the classifier module is configured to fuse and analyze, based on the FCNN, the first and second groups of optimum beam probabilities that are normalized and whose weights are adjusted to output a final optimum beam probability.

6. The millimeter-wave beam tracking method in the microwave and millimeter wave heterogeneous network scenario according to claim 5, wherein
in step S3, the DNN fusion model is pre-trained in a self-supervised or supervised training manner;
in the self-supervised training manner, the training data is historical time sequence microwave channel information and user location information; and
in the supervised training manner, the training data is historical time sequence microwave channel information, user location information, and the corresponding optimum beam label.

7. The millimeter-wave beam tracking method in the microwave and millimeter wave heterogeneous network scenario according to claim 6, wherein
in the self-supervised training manner, the training loss function is expressed as:
$${L}_{s} = {L}_{s}^{sub - 6} + {L}_{s}^{loc} + {L}_{s}^{fu} = - \vert {{H}_{mmW}^{( {k}_{sub - 6} )} ( t )}^{H} {f}_{{m}_{sub - 6}}^{( {k}_{sub - 6} )} {\vert}^{2} - \vert {{H}_{mmW}^{( {k}_{loc} )} ( t )}^{H} {f}_{{m}_{loc}}^{( {k}_{loc} )} {\vert}^{2} - \vert {{H}_{mmW}^{( {k}_{fu} )} ( t )}^{H} {f}_{{m}_{fu}}^{( {k}_{fu} )} {\vert}^{2} ;$$
wherein Lₛ^{sub-6},Lₛ^{loc}, and Lₛ^{fu} are the loss functions of the microwave feature extraction module, the location feature extraction module, and the feature fusion module, respectively; and k_{sub-6}, m_{sub-6}, k_{loc}, m_{loc}, k_{fu}, and m_{fu} represent the access base stations and beams selected according to beam prediction results obtained by the microwave feature extraction module, the location feature extraction module, and the feature fusion module, respectively.

8. The millimeter-wave beam tracking method in the microwave and millimeter wave heterogeneous network scenario according to claim 6, wherein
in the supervised training manner, the training loss function is expressed as:
$$L = {L}_{CE}^{sub - 6} + {L}_{CE}^{loc} + {L}_{CE}^{fu} = - {\sum }_{m = 1}^{KM} {δ}_{m} ( t ) ( {log}_{2} ( {p}_{m}^{sub - 6} ) + {log}_{2} ( {p}_{m}^{loc} ) + {log}_{2} ( {p}_{m} ) ) ;$$
wherein L_{CE}^{sub-6}, L_{CE}^{loc}, and L_{CE}^{fu} are cross entropy loss functions of the microwave feature extraction module, the location feature extraction module, and the feature fusion module, respectively; {δ₁(t), . . . , δₘ(t), . . . , δ_{KM}(t)} is a one-hot vector that represents the optimum beam at moment t, that is, if m*(t)=m, δₘ(t)=1 ; otherwise, δₘ(t)=0; KM=K×M; pₘ^{sub-6} is a probability that the microwave feature extraction module determines that each beam is an optimum beam; pₘ^{loc} is a probability that the location feature extraction module determines that each beam is an optimum beam; and pₘ is a probability that the feature fusion module determines that each beam is an optimum beam.

9. The millimeter-wave beam tracking method in the microwave and millimeter wave heterogeneous network scenario according to claim 6, wherein
based on the established beam tracking problem, a mapping from historical time sequence microwave channel information and user location information to the millimeter-wave optimum beam is established, and an optimum beam label that is corresponding to historical time sequence microwave channel information and user location information and that is required for supervised training is obtained; and
the established mapping from the historical time sequence microwave channel information and the user location information to the millimeter-wave optimum beam is:
$$Φ : {\{ {H}_{sub - 6} ( t - τ ) , q ( t - τ ) \}}_{τ = 1}^{T} \to \{ {k}^{⋆} ( t ) , {m}^{⋆} ( t ) \} ;$$
wherein T represents the time length of the historical time sequence microwave channel information, H_{sub-6}(t−τ) represents the microwave channel state at moment t−τ; q(t−τ) represents the user location at moment t−τ; and k*(t) represents the index of the millimeter-wave optimum base station at moment t, and m*(t) represents the index of the millimeter-wave optimum beam at moment t.

10. The millimeter-wave beam tracking method in the microwave and millimeter wave heterogeneous network scenario according to claim 9, wherein
the mapping from the historical time sequence microwave channel information and the user location information to the millimeter-wave optimum beam is established by using a DNN; and the corresponding optimum beam is obtained according to the historical time sequence microwave channel information and the user location information.
